(19) United States
(12) Patent Application Publication
(10) Pub. No.: US 2025/0077790 A1
(43) Pub. Date: Mar. 6, 2025

(54) SECOND-CHANCE MESSAGE ENHANCEMENTS

(71) Applicant: Microsoft Technology Licensing, LLC, Redmond, WA (US)

(72) Inventors: Elizabeth Rose JESTER, Edmonds, WA (US); Daniel Steven LECLAIR, Kenmore, WA (US); Poonam Ganesh HATTANGADY, Seattle, WA (US); Telmen Gerel DZJIND, Redmond, WA (US); Sivaprasad Radhakrishnan LAKSHMI, Dublin, CA (US)

(73) Assignee: Microsoft Technology Licensing, LLC, Redmond, WA (US)

(21) Appl. No.: 18/457,866

(22) Filed: Aug. 29, 2023

(51) Int. Cl. G06F 40/40; G06F 40/174; G06F 40/279; H04L 51/02; H04L 51/063; G06F 3/0482; G06F 3/0484

(52) U.S. Cl. CPC G06F 40/40; G06F 40/174; G06F 40/279; H04L 51/02; H04L 51/063; G06F 3/0482; G06F 3/0484

(57) ABSTRACT

The technology relates to systems and methods for generating advanced feedback for a draft message. The operations may include receive text for a message being drafted in a messaging application; upon an analysis condition being satisfied, analyze the message by applying at least one of a message-analysis model or heuristic to generate a feedback score for the message; and based on the feedback score crossing a feedback threshold, trigger generation of advanced feedback for the message. The operations may also or alternatively include receive an initial sent message from a messaging application; analyze the message by applying at least one of a message-analysis model or heuristic to generate a feedback score for the message; based on the feedback score crossing a feedback threshold, transmit a feedback alert message for surfacing in the messaging application; and based on receiving an interaction, trigger generation of advanced feedback for the message.

### BACKGROUND

Productivity applications are designed to help entities (e.g., individuals and organizations) generate content and data (e.g., electronic communications, schedules, documents, projects) more efficiently. Some productivity applications are used to receive, compose, and respond to electronic communications, such as emails, text messages, chat messages, etc. (generally, messages). Generating new messages and drafting new messages proves to be challenging and often requires additional rewriting and edits that reduce the overall functionality and efficiency of the messaging applications and their intended uses.

It is with respect to these and other considerations that examples have been made. In addition, although relatively specific problems have been discussed, it should be understood that the examples should not be limited to solving the specific problems identified in the background.

### SUMMARY

Examples described in this disclosure relate to systems and methods for triggering the generation of advanced feedback for draft messages using combinations of heuristics, models, and/or generative artificial intelligence (AI) models (e.g., language models). In an example, as a message is being drafted, a set of heuristics and/or a model may be applied to the content of the message to determine if the message is likely to benefit from advanced feedback generated from a generative AI model. If the heuristics and/or model indicates that the advanced feedback should be generated, a feedback notification is surfaced in the user interface of the messaging application. Selection of the notification may cause the advanced feedback to be generated by the generative AI model. In such examples, the execution of the resource-intensive generative AI model may be reserved for instances where the outputs from the generative AI model are more likely to be useful.

In other examples, when the heuristics and/or model indicates that the advanced feedback should be generated, the generation of the automatic feedback may be automatically triggered. As such, the latency involved with processing time associated with the generative AI model may become imperceptible to the user. For instance, when the notification or other UI element is selected, the advanced feedback may then be immediately displayed.

Additionally or alternatively, after a “send” indication is received from the user, the initial sent message may be held by a messaging server. While being held at the server, the heuristics and/or models are then applied to the initial sent message to determine if advanced feedback should be provided for the message. If the heuristics and/or model indicate that advanced feedback should be applied, the message continues to be held and an alert message is sent to the messaging application to alert the user that the message has not been delivered. The initial sent message may then be returned to draft form for editing by the user based on the advanced feedback. Once message has been revised, the message may then be sent and delivered to the recipient(s) of the message.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of a system in which an advanced message feedback system is implemented according to an example.

FIG. 2A is a block diagram of example components of an example advanced message feedback system.

FIG. 2B is a block diagram of example components of another example advanced message feedback system.

FIG. 3A depicts an example interface for triggering advanced feedback for a message.

FIG. 3B depicts another example interface for triggering advanced feedback for a message.

FIG. 4A depicts an example interface for generating advanced feedback for a message.

FIG. 4B depicts another example interface for generating advanced feedback for a message.

FIG. 4C depicts another example interface for generating advanced feedback for a message.

FIG. 4D depicts another example interface for generating advanced feedback for a message.

FIG. 5 depicts an example method of triggering advanced feedback for messages.

FIG. 6 depicts another example method of triggering advanced feedback for messages.

FIG. 7 is a block diagram illustrating example physical components of a computing device with which aspects of the disclosure may be practiced.

### DETAILED DESCRIPTION

Examples described in this disclosure relate to systems and methods for triggering the generation of advanced feedback for draft messages using combinations of heuristics, models, and/or generative AI models (e.g., language models). In an example, as a message is being drafted, a set of heuristics and/or a model may be applied to the content of the message to determine if the message is likely to benefit from advanced feedback generated from a generative AI model. If the heuristics and/or model indicates that the advanced feedback should be generated, a feedback notification is surfaced in the user interface of the messaging application. Selection of the notification may cause the advanced feedback to be generated by the generative AI model. In such examples, the execution of the resource-intensive generative AI model may be reserved for instances where the outputs from the generative AI model are more likely to be useful.

In other examples, when the heuristics and/or models indicate that the advanced feedback should be generated, the generation of the automatic feedback may be automatically triggered. As such, the latency involved with processing time associated with the generative AI model may become imperceptible to the user. For instance, when the notification or other UI element is selected, the advanced feedback may then be immediately displayed.

Additionally or alternatively, after a “send” indication is received from the user, the initial sent message may be held by a messaging server. While being held at the server, the heuristics and/or models are then applied to the initial sent message to determine if advanced feedback should be provided for the message. If the heuristics and/or model indicate that advanced feedback should be applied, the message continues to be held and an alert message is sent to the messaging application to alert the user that the message has not been delivered. The initial sent message may then be returned to draft form for editing by the user with the advanced feedback. Once message has been revised, the message may then be sent and delivered to the recipient(s) of the message.

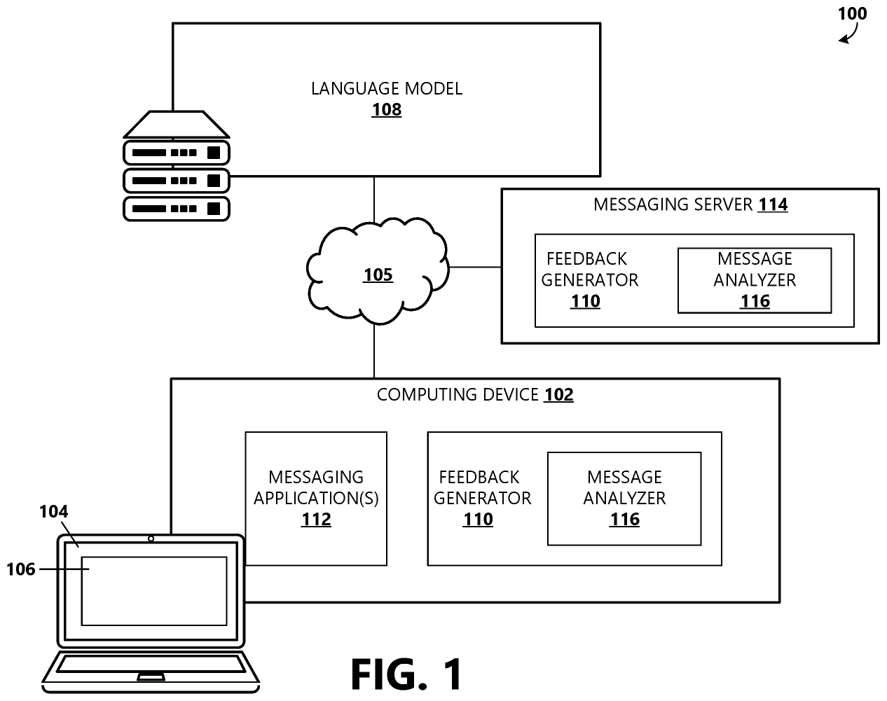

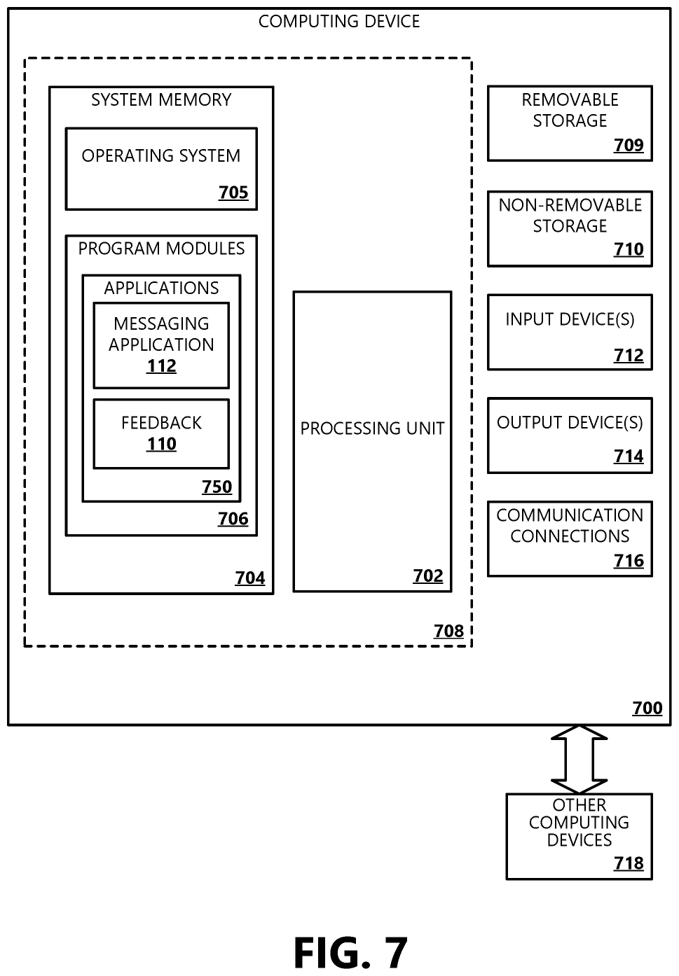

FIG. 1 is a block diagram of an example system 100 for providing advanced feedback in accordance with an example. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) comprising such an operating environment is depicted in FIG. 7. In another example, the components of systems disclosed herein are distributed across multiple processing devices. For instance, input may be entered on a user device or client device and information may be processed on or accessed from other devices in a network, such as one or more remote cloud devices or web-based server devices.

The example system 100 generates advanced feedback using a language model 108, which may be an LLM, a multimodal model, or other types of generative AI models. Example models may include the GPT models from OpenAI, BARD from Google, and/or LLaMA from Meta, among other types of generative AI models. According to an aspect, the system 100 includes a computing device 102 that may take a variety of forms, including, for example, desktop computers, laptops, tablets, smart phones, wearable devices, gaming devices/platforms, virtualized reality devices/platforms (e.g., virtual reality (VR), augmented reality (AR), mixed reality (MR)), etc. The computing device 102 has an operating system that provides a graphical user interface (GUI) that allows users to interact with the computing device 102 via graphical elements, such as application windows (e.g., display areas), buttons, icons, and the like. For example, the graphical elements are displayed on a display screen 104 of the computing device 102 and can be selected and manipulated via user inputs received via a variety of input device types (e.g., keyboard, mouse, stylus, touch, spoken commands, gesture).

In examples, the computing device 102 includes a plurality of productivity applications (collectively, productivity applications) for performing different tasks, such as communicating, information generation and/or management, data manipulation, visual construction, resource coordination, calculations, etc. According to an example implementation, the productivity applications include at least one messaging application 112 that operates to allow users to send and receive messages. Messages can be in various formats, such as text, audio, images, and/or video. Example messaging applications 112 include, but are not limited to, an email application, a messaging application, a chat application, a voicemail application, enterprise software, an information worker application, and the like. The messaging application(s) 112 may be local applications or web-based applications accessed via a web browser. Each messaging application 112 has one or more application UIs 106 by which a user can view and generate messages and interact with features provided by the messaging application 112. For example, an application UI 106 may be presented on the display screen 104. In some examples, the operating environment is a multi-application environment by which a user may view and interact with multiple messaging applications 112 through multiple application UIs 106.

According to examples, the system 100 further includes a feedback generator 110 that generates the advanced feedback for a draft message, as discussed herein. In some examples, the draft message is a new message (e.g., a first communication in a conversation thread). In other examples, the draft message is a reply message (e.g., a subsequent communication to the first communication in a conversation thread). In some implementations, the feedback generator 110 is included in one or more messaging applications 112. According to an example, the feedback generator 110 is a separate module that is communicatively integrated into one or more messaging applications 112 via an application programming interface (API). As will be described in further detail below, the feedback generator 110 provides functionality for generating content for a suggested message and determining whether advanced feedback should be generated.

In an example implementation, the feedback generator 110 generates an AI prompt, for the language model 108, that requests the feedback for the message. The language model 108 then generates an output payload in response to the AI prompt. The output payload is parsed and otherwise processed to generate and display the advanced feedback discussed herein.

The feedback generator 110 may also include a message analyzer 116 that analyzes messages to determine if advanced feedback should be generated for the message (e.g., if the message would likely benefit from the advanced feedback). The message analyzer 116 applies a set of message-analysis heuristics and/or models (e.g., AI and/or machine learning (ML) models) to make such determinations. For instance, the message analyzer 116 may analyze different portions of the message, such as the recipients, the subject, and/or the body of the message. In cases where the message being drafted is a reply message, the message analyzer may analyze the prior messages in the message thread as well. The heuristics and/or models that are applied may require fewer computing resources than the execution of the generative AI model. Accordingly, the heuristics and/or model of the message analyzer 116 may be executed locally and/or more frequently while still ultimately conserving computing resources of overall system by limiting calls to the language model 108 until there is likely benefit from the advanced feedback generated by the language model 108.

According to example implementations, the language model 108 is trained to understand and generate sequences of tokens, which may be in the form of natural language (e.g., human-like text). In various examples, the language model 108 can understand complex intent, cause and effect, perform language translation, semantic search classification, complex classification, text sentiment, summarization, summarization for an audience, and/or other natural language capabilities.

In some examples, the language model 108 is in the form of a deep neural network that utilizes a transformer architecture to process the text it receives as an input or query. The neural network may include an input layer, multiple hidden layers, and an output layer. The hidden layers typically include attention mechanisms that allow the language model 108 to focus on specific parts of the input text, and to generate context-aware outputs. Language model 108 is generally trained using supervised learning based on large amounts of annotated text data and learns to predict the next word or the label of a given text sequence.

The size of a language model 108 may be measured by the number of parameters it has. For instance, as one example of an LLM, the GPT-4 model from OpenAI has billions of parameters. These parameters may be weights in the neural network that define its behavior, and a large number of parameters allows the model to capture complex patterns in the training data. The training process typically involves updating these weights using gradient descent algorithms, and is computationally intensive, requiring large amounts of computational resources and a considerable amount of time. The language model 108 in examples herein, however, is pre-trained, meaning that the language model 108 has already been trained on the large amount of data. This pre-training allows the model to have a strong understanding of the structure and meaning of text, which makes it more effective for the specific tasks discussed herein.

The language model 108 may operate as a transformer-type neural network. Such an architecture may employ an encoder-decoder structure and self-attenuation mechanisms to process the input data (e.g., the prompt). Initial processing of the prompt may include tokenizing the prompt into tokens that may then be mapped to a unique integer or mathematical representation. The integers or mathematical representations combined into vectors that may have a fixed size. These vectors may also be known as embeddings.

The initial layer of the transformer model receives the token embeddings. Each of the subsequent layers in the model may use a self-attention mechanism that allows the model to weigh the importance of each token in relation to every other token in the input. In other words, the self-attention mechanism may compute a score for each token pair, which signifies how much attention should be given to other tokens when encoding a particular token. These scores are then used to create a weighted combination of the input embeddings.

In some examples, each layer of the transformer model comprises two primary sub-layers: the self-attention sub-layer and a feed-forward neural network sub-layer. The self-attention mechanism mentioned above is applied first, followed by the feed-forward neural network. The feed-forward neural network may be the same for each position and apply a simple neural network to each of the attention output vectors. The output of one layer becomes the input to the next. This means that each layer incrementally builds upon the understanding and processing of the data made by the previous layers. The output of the final layer may be processed and passed through a linear layer and a softmax activation function. This outputs a probability distribution over all possible tokens in the model's vocabulary. The token(s) with the highest probability is selected as the output token(s) for the corresponding input token(s).

In example implementations, the language model 108 operates on a device located remotely from the computing device 102. For instance, the computing device 102 may communicate with the language model 108 using one or a combination of networks 105 (e.g., a private area network (PAN), a local area network (LAN), a wide area network (WAN)). In some examples, the language model 108 is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

In some examples, the heuristics and/or models may be based on one or more of the following: length of the message (e.g., threshold amount of text); number of recipients (e.g., more than threshold number of recipients indicates feedback likely helpful); the relationship with recipients, hierarchy, affinity, frequency of communication (e.g., messaging a supervisor may benefit from feedback), whether the recipients are internal or external (e.g., recipients in the same or different domain than the sender), how much time has been spent working on the draft message, whether it is the first time messaging the recipient, amount of the message that has been retyped, number of times the message has been retyped, profanity, dangerous language, tone or writing style (e.g., not matching tone of other messages in message thread), topics detected in message, advice given in message, emotive terms used in message, urgency of message, and sensitive topics (e.g., diversity, inclusion, death, layoffs), among others.

Different heuristics and/or models may be applied for each of the different categories discussed above. In some examples, each of the models and/or heuristics generate a relative score that is combined to generate a feedback score that is compared to a threshold. If the feedback score exceeds the threshold, the message would likely benefit from the advanced feedback. An alert message or feedback notification may then be generated that is surfaced through the messaging application to indicate to the user that the message may benefit from advanced feedback and revisions.

In some examples, the message analyzer 116 analyzes the message locally (e.g., on the computing device 102) as the message is being drafted. In such examples, the feedback generator 110 and message analyzer 116 may reside locally as well. The analysis of the message may be triggered based on different intervals and/or conditions. For instance, the message may be analyzed on a set time interval (e.g., every 10 seconds), after a number of words or characters have been entered, after a period, or after a pause in typing, among other possible conditions.

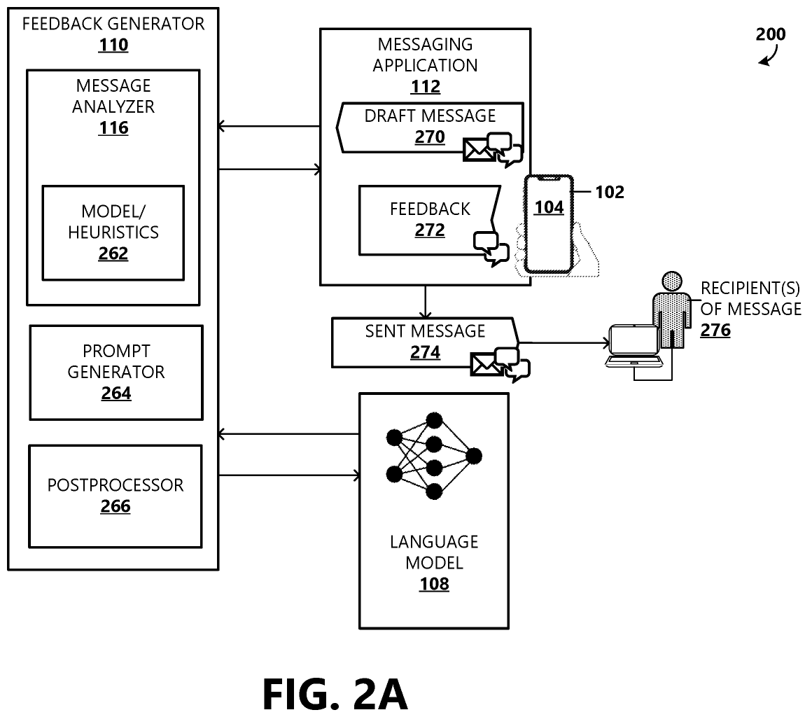

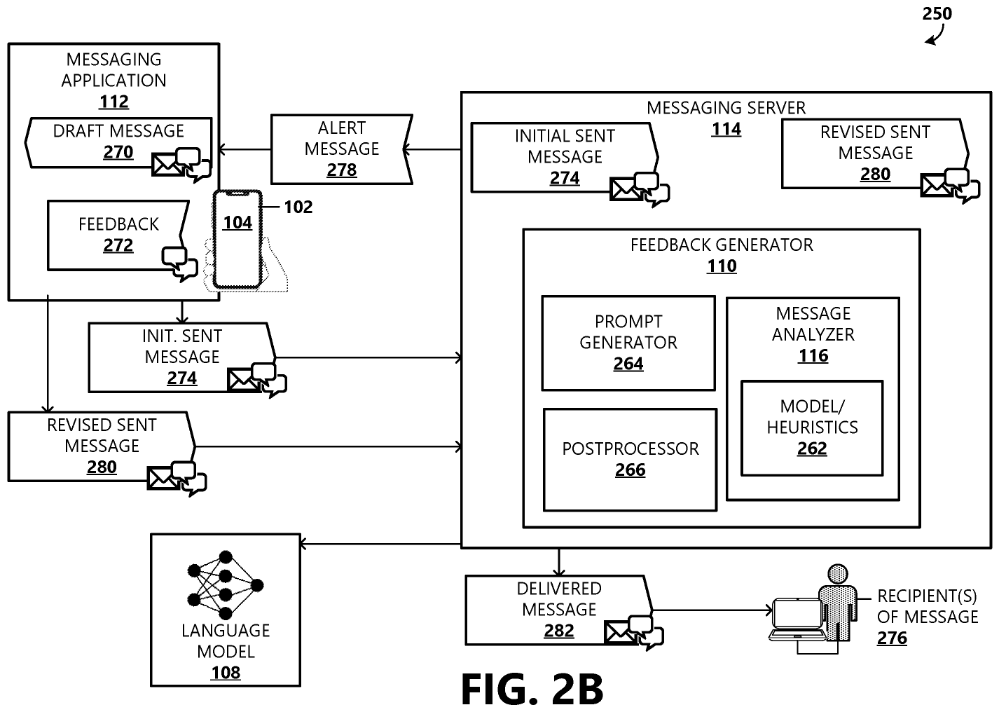

Additionally or alternatively, the message analyzer 116 may analyze the message after the message has been initially sent (e.g., after the “send” button has been selected). In such examples, the system 100 may also include a messaging server 114 that includes and/or executes the feedback generator 110 and/or the message analyzer 116. For example, when the send button is pressed, the message is sent from the computing device 102 to the messaging server 114. The messaging server 114 then holds the message from ultimate delivery to the recipient while the message analyzer 116 analyzes the message. The message analyzer 116 then analyzes the message in the same or similar manner as the local draft is, or would have been, analyzed. If the server-based message analyzer 116 determines that the message would benefit from advanced feedback, an alert is generated and surfaced in the messaging application. The message then continues to be held for a period of time, which may be configurable in some examples. If an interaction with the surfaced alert is received within the period of time, the message is returned to draft form and revised with the advanced feedback at the messaging application. A revised draft is then sent to the messaging server and ultimately delivered to the recipient(s). If an interaction with the alert (or other activation UI element) is not received within the set period of time, the message is delivered without further revisions or advanced feedback being provided. These and other examples are described in further detail below with respect to FIGS. 2-7.

FIG. 2A is a block diagram of example components of an advanced message feedback system 200. The system includes features for analyzing a draft message while the message is being drafted.

The system 200 includes a feedback generator 110 that includes the message analyzer 116, a prompt generator 264, and a postprocessor 266. The message analyzer 116 includes models and/or heuristics 262 for analyzing the draft message to determine if the draft message would benefit from advanced feedback.

The feedback generator 110 is in communication with the messaging application 112. The messaging application 112 includes, or provides access to, a draft message 270 that is currently being drafted by the user within a user interface of the messaging application. The messaging application 112 may also cause the display of advanced feedback 272 generated by the feedback generator 110. The feedback generator 110 is also in communication with the language model 108.

The feedback generator 110 may be a part of (e.g., a component of) the messaging application 112. For instance, the feedback generator 110 may form a portion of the software code that defines the messaging application 112. In other examples, the feedback generator 110 may be part of a separate service or application.

When a user is drafting a message, the advanced feedback features of the technology discussed herein are automatically triggered or triggered in response to the selection of a UI element. For instance, as the message 270 is being drafted, the message analyzer 116 applies the model(s) and/or heuristic(s) to determine if the draft message 270 would benefit from advanced feedback. If the message analyzer 116 determines that the draft message 270 would benefit from the advanced feedback, the message analyzer 116 causes an alert to be displayed in the messaging application 112. Additionally or alternatively, if the message analyzer 116 determines that the draft message 270 would benefit from the advanced feedback, the message analyzer may automatically trigger the generation of the advanced feedback discussed herein. If the message analyzer 116 determines that the draft message 270 is less likely to benefit from the advanced feedback, the message analyzer 116 continues to analyze the draft message 270 as it is being drafted.

The generation of the advanced feedback may be triggered in different manners. In one example, generation of the advanced feedback is triggered in response to the determination from the message analyzer 116 that the draft message 270 would benefit from the feedback. In other examples, the generation of the advanced feedback is triggered in response to receiving an interaction with a feedback notification or alert surfaced in the messaging application 112 that indicates advanced feedback would benefit the message. In still other examples, the generation of the advanced feedback is triggered in response to receiving a selection of a feedback UI element of the messaging application 112.

When the advanced feedback features are triggered, the draft message 270 is further processed by the feedback generator 110 to generate an AI prompt. For instance, the prompt generator 264 generates an AI prompt for the language model 108. The AI prompt includes the details of the draft message 270, such as the body of the message, the subject of the message, and/or the recipients of the message. In examples where the draft message 270 is part of a conversation thread (e.g., a reply or forward message), details of the conversation thread may also be included in the AI prompt.

The AI prompt may also include data related to the outputs from the models and/or heuristics 262 that were applied to the draft message by the message analyzer 116. For instance, the scores produced by the models and/or heuristics 262 along with the categories may be incorporated into the AI prompt. As example, for a profanity metric, data such as “Profanity: 7/10” indicating a profanity score of 7 out of 10 may be incorporated into the AI prompt. Since this data has already been generated by the message analyzer 116, this additional data may provide additional context for the language model 108 to generate the advanced feedback.

An example AI prompt may be as follows:

<EMAIL_THREAD>
// the email being replied to goes here
</EMAIL_THREAD>
<REPLY>
// The user's currently composed draft reply that they are getting
feedback on
</REPLY>
<HEURISTIC/MODEL OUTPUT>
//Data from the initial analysis of the message
</HEURISTIC/MODEL OUTPUT >
[REQUEST INSTRUCTIONS] Based on the email above and the above
analysis data, provide feedback to ensure the email sounds professional
and energizing to the team.
Feedback should always be kind, supportive and encouraging
For negative feedback, use passive voice. Use soft phrases like “you can
explain better” rather than “you do not explain” to the feedback doesn't
come across as harsh or accusatory
[OUTPUT FORMATTING INSTRUCTIONS] Use Markdown table
format: | Area | A short feedback in no more than 4 words | 1 standardized
Unicode emoji that best represents this feedback | A detailed explanation
in no more than 50 words | 2 examples of how to improve words or
phrasing and why | Write n/a in the column, if it's not applicable.
[TOPIC INSTRUCTIONS] Provide feedback on these topics:
Overall tone
Reader Sentiment
Lack of specificity and details
Clarity

The example AI prompt above includes both dynamic segments and static segments. The dynamic segments include the data that is populated from the current draft message and/or conversation details (e.g., <EMAIL_THREAD>, <REPLY>) and model/heuristic data. In contrast to the dynamic segments, the static segments may remain the same for each AI prompt that is generated. The static segments may include items such as the [REQUEST INSTRUCTIONS], [OUTPUT FORMATTING INSTRUCTIONS], and [TOPIC INSTRUCTIONS].

The request instructions provide instructions for what is requested of the language model 108. This can include the processes that are to be performed and how those processes are to be performed. In addition, preventative guardrails may also be included that prevent certain type of outputs (e.g., feedback) from being generated. The tone or style of the feedback may also be specified within the request instructions.

The output formatting instructions include instructions or details for how the output payload is to be formatted or structured. For instance, in the example above, the output formatting instructions include that the output payload should be in a markdown format with specific delimiters. By including such formatting instructions, a more predictable output is generated, and the output can be more consistently parsed. Unlike some AI models that have a set format for the output (e.g., a predefined array), generative AI models generally do not output such a consistent and/or structured data format. Such a conglomeration of unstructured data can be difficult to parse, and may lead to improper or non-sensical outputs. By specifying the format requirements of the output within the AI prompt itself, the overall consistency and performance of the advanced feedback systems are improved.

The topic instructions provide specific topics for which feedback should be generated. In some examples, the topics may be configurable by the user. Custom topics may also be set by the user via natural language. For instance, in a configuration setting of the advanced feedback system, the user may add any type of natural language topic for feedback to be generated.

The generated AI prompt from the prompt generator 264 is then provided as input to the language model 108. The language model 108 processes the AI prompt and generates an output payload in response to the AI prompt. The output payload is received by the feedback generator 110. The postprocessor 266 then processes the output payload to generate the advanced feedback 272. The post-processing operations may include parsing the output payload to extract defined segments of the output payload. The parsing may be possible (or at least improved) due to the formatting of the output payload that is caused by the output formatting instructions provided in the AI prompt. The post-processing may also include filtering, cleaning, or otherwise sanitizing the output payload to ensure inappropriate content was not provided by the language model 108. The post-processing also includes further formatting of the data in the output payload into the user interface features of the feedback 272, as discussed further below. The postprocessed feedback data is then provided to the message application 112 where the advanced feedback 272 may be displayed and interacted with.

Once the advanced feedback 272 is displayed, the draft message may be edited according to the advanced feedback 272. Such editing of the draft message 270 may occur manually by the user interpreting the feedback. In other examples, the feedback may be automatically applied to edit the draft message 270. The edited message is then sent to the recipient(s) 276 of the message, where the draft message 270 then becomes a sent message 274.

FIG. 2B depicts is a block diagram of example components of another example advanced message feedback system 250. The system 250 in FIG. 2B operates to analyze the message after the message has been sent to the messaging server (e.g., after the user selects “Send”). The system 250 includes many of the same or similar components as system 200 in FIG. 2A. However, as depicted, the feedback generator 110 and the components thereof operate on the messaging server 114.

In the system 200, the draft message 270 is prepared and sent to the messaging server 114 as an initial sent message 274. The initial sent message 274 is then held by the server 114 for a period of time. While the initial sent message 274 is held, the message analyzer 116 analyzes the message 274 by applying the model(s) and/or heuristic(s) as discussed further herein.

When the message analyzer 116 determines that the initial sent message 274 would benefit from the advanced feedback, the message analyzer 116 generates an alert message that is transmitted to the messaging application 112 where it is surfaced (e.g., displayed or caused to be displayed). The alert message 278 may be surfaced in the form of another message in the inbox for the user, a popup alert, a push notification, or other type of indication.

If there is no interaction with the alert message within a set period of time, the initial sent message 274 is transmitted (unchanged) to the recipient(s) 276 as the delivered message 282. If an interaction with the alert message 278 is received within the set time period, the initial message 274 is returned to its draft message 270 form to allow for further revisions. In addition, the advanced feedback generation may also be triggered. The generation of the advanced feedback may be performed in substantially the same manner as discussed above.

The advanced feedback 272 is then surfaced in the messaging application 112. The draft message 270 is further revised according to the advanced feedback 272. The message is then sent to the messaging server 114 as a revised sent message 280. In some examples, the revised sent message 280 may be again held and analyzed by the message analyzer 116. In other examples, the message analyzer 116 does not again analyze the revised sent message 280 because an earlier version (e.g., the initial sent message 274) was already analyzed and revised. The revised sent message is then transmitted to the specified recipient(s) as the delivered message 282.

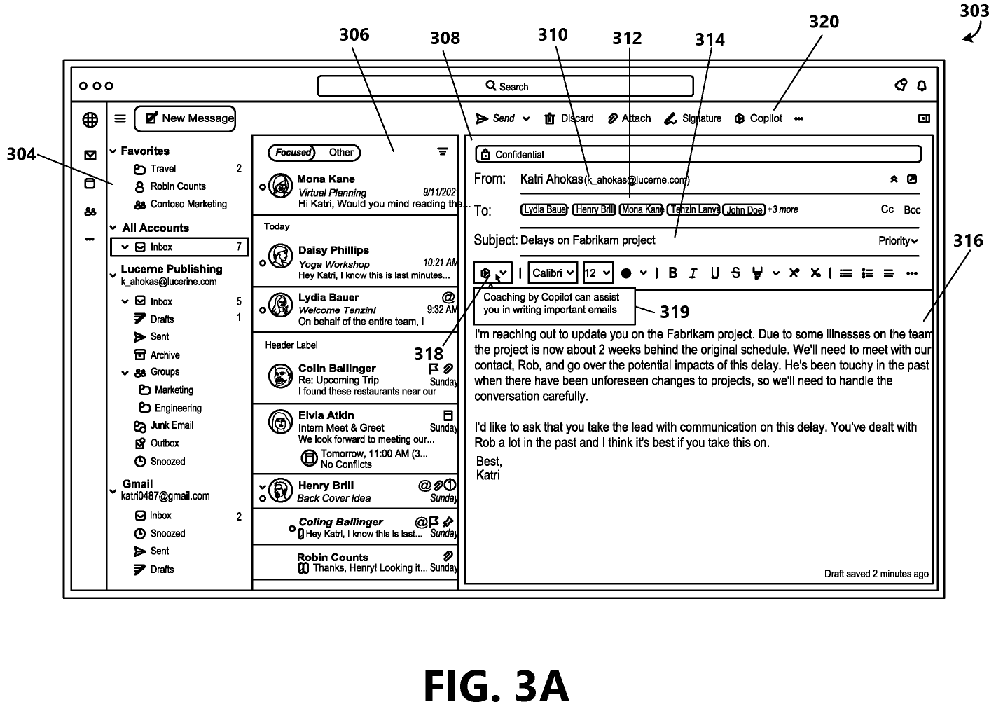

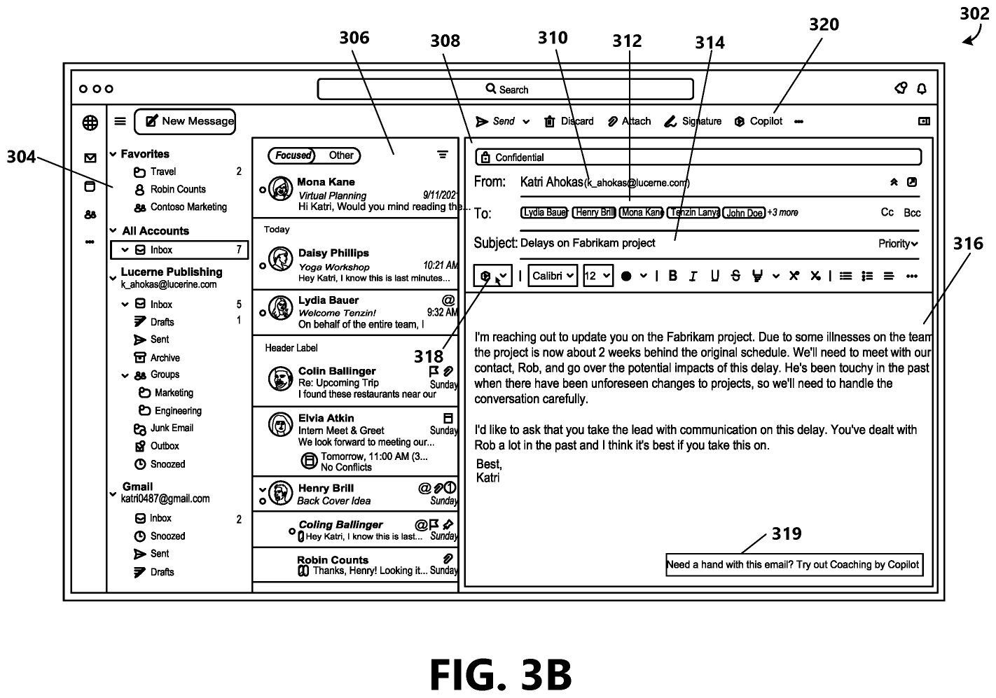

FIG. 3A depicts an example interface 302 for triggering advanced feedback for a message. The interface 302 is of a messaging application, and the interface 302 may be referred to as a messaging-application interface 302. In particular, the example interface 302 is for an e-mail application. The interface 302 includes a folder panel 304 that lists a number of message folders, such as an inbox folder, sent messages folder, etc. A message preview panel 306 is included adjacent to the folder panel 304. The message preview panel 306 includes a list of messages that may be selected. The messages in the preview panel 306 may include a preview of information about each of the messages, such as the sender, subject, time sent, and a portion of the body of the message.

A message detail panel 308 is shown adjacent the preview panel. The detail panel 308 shows details of the draft message being drafted and allows the user to draft and/or edit the message. The detail panel 308 includes a from field 310 that lists the sender (e.g., the user to whom the interface 302 is displayed), and a recipient field 312 that lists the recipients of the draft message. The user may edit the recipients by adding or removing users from the recipient field 312. The detail panel 308 further includes a subject field 314 where the subject of the message may be edited. In addition, a body field 316 is also included in the detail panel where the body of the message may be edited.

The detail panel 308 may also include a feedback user interface (UI) element 318 that may be selected to activate AI features of the technology discussed herein. For instance, in the example depicted, selection of the AI UI element 318 causes a drop-down menu to be displayed. The drop-down menu may include an option for AI-assisted drafting (e.g., “Draft with Copilot”) and an option for advanced feedback features (e.g., “Coaching by Copilot”). In the example depicted, the AI UI element 318 is displayed with font and formatting options, which may be displayed between the subject field 314 and the body field 316.

In other examples, different or additional AI-activation elements 320 may be provided in the interface 302. For instance, an AI-activation element 320 may be provided in a menu bar for controls of the message. In other examples, the AI-activation element is included in the ribbon or main menu portions of the application interface 302.

The interface 302 also includes a feedback notification 319 that indicates that message being drafted may benefit from the advanced feedback features discussed herein. The feedback notification 319 is generated and surfaced in response to message analyzer 116 determining that the message would benefit from the advanced feedback discussed herein. The feedback notification 319 may provide text or content such as “Coaching by Copilot can assist you in writing important emails,” among other examples. In some examples, the feedback notification may also include additional data based on the models and/or heuristics that were applied by the message analyzer 116. For instance, data relating to the highest scores from the models and/or heuristics may be included in the feedback notification 319. For example, if the profanity heuristic was above a threshold or one of the top scores from the heuristics, the feedback notification 319 may indicate that the message includes profanity and the advanced feedback may be useful in revising the message to reduce or remove the profanity.

The feedback notification 319 may be displayed in manner that is limited in size and is less likely to interfere with the ongoing drafting of the message. For instance, the feedback notification 319 may take up less than 10% or 5% of the user interface of the messaging application when displayed. The feedback notification 319 may also be displayed in a manner where the display of the feedback notification 319 does not cause the active element to be changed. For example, as the user is typing in the body field, the display of the feedback notification 319 will not cause the focus or active area to no longer be the body field.

The feedback notification 319 may be selectable in some examples. For instance, selection of the feedback notification 319 may cause the advanced feedback to be generated. In other examples, the feedback notification 319 is not selectable. Rather, the feedback notification 319 indicates a location of one or more of the feedback activation elements 318, 320.

When the feedback notification 319 and/or one of the feedback activation elements 318, 320 are selected, the generation of the advanced feedback is triggered. For instance, the draft message is sent to the feedback generator 110 for advanced feedback on the draft message to be generated. As an example, the data in the recipient field 312, subject field 314, and/or body field 316 of the draft message may be sent to the feedback generator 110 for inclusion in the AI prompts discussed herein.

FIG. 3B depicts another example interface 303 for triggering advanced feedback for a message. The example interface 303 is substantially similar to the interface 302 of FIG. 3A with the exception that the feedback notification 319 is in a different form. In the interface 303 of FIG. 3B, the feedback notification 319 is positioned in a lower portion of the body field 316 such that it does not occlude any of the text in the body field 316. Such a positioning improves the usability of the interface as the user is able to continue drafting, without occlusions, even with the display of the feedback notification 319.

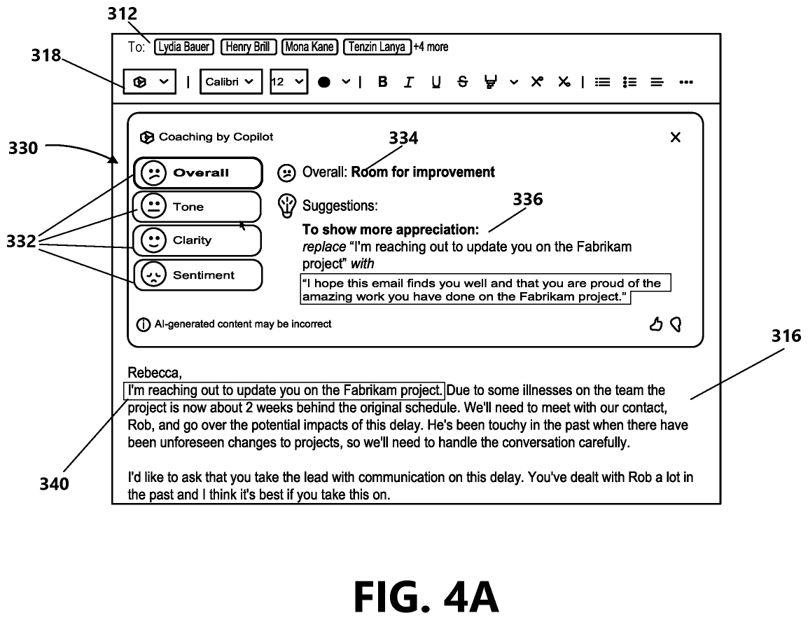

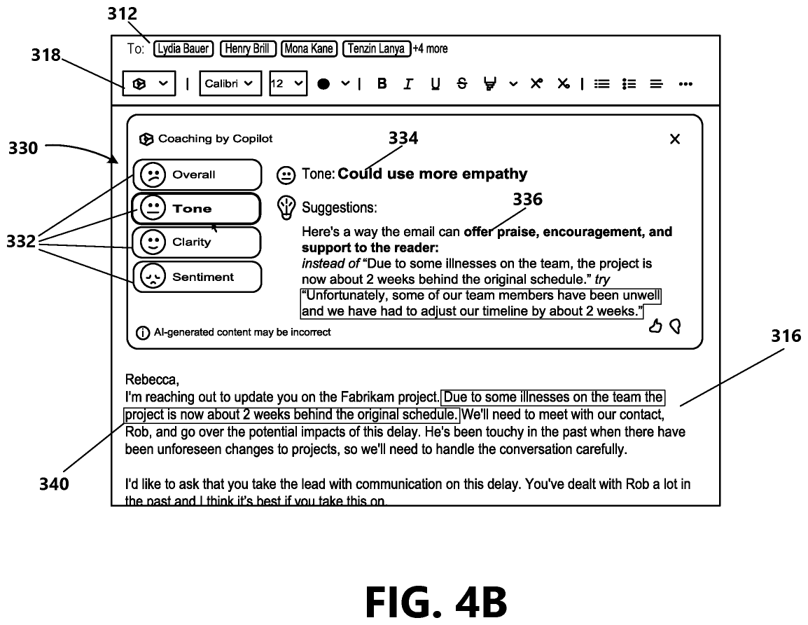

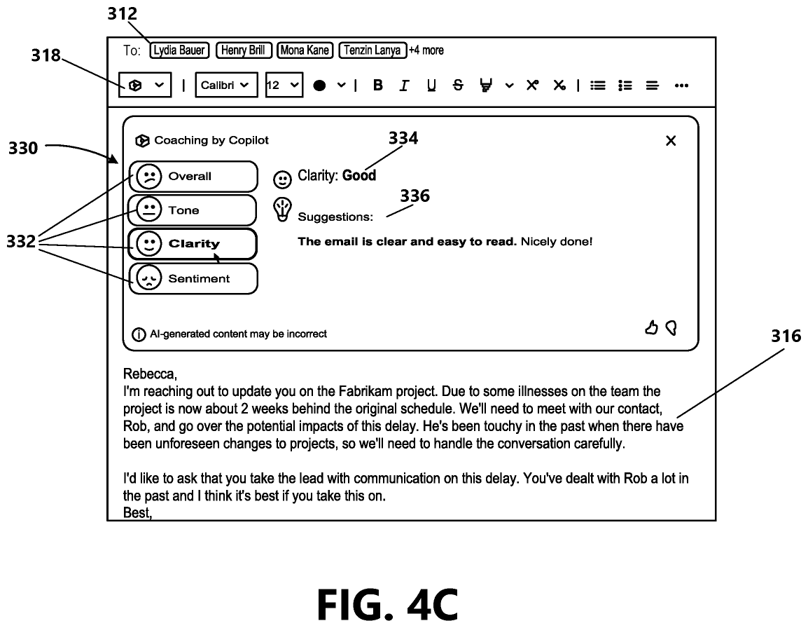

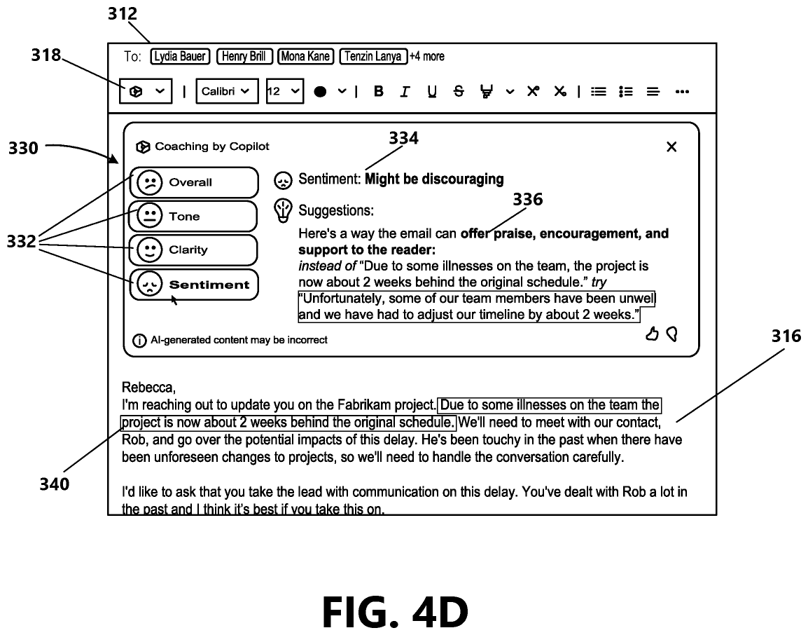

FIG. 4A depicts another example interface for generating advanced feedback for a message. In particular, FIG. 4A shows the message detail panel 308 after the feedback has been received from the feedback generator 110. In the example depicted, the feedback is shown in a feedback subpanel 330 of the message detail panel 308. The feedback subpanel 330 may be displayed adjacent to the body field 316, such as between the subject field 314 and the body field 316 and/or between the recipient field 312 and the body field 316. By positioning the feedback subpanel 330 adjacent the body field, the limited display area is optimally used such that data in the body field 316 and the feedback subpanel 330 may be concurrently viewed. Such an arrangement leads to improved interaction performance and reduced error rates in applying the advanced feedback set forth in the feedback subpanel.

The feedback subpanel 330 includes selectable topic options 332. The selectable topic options 332 correspond to the different topics set forth in the topic instructions of the AI prompt that was used to generate the feedback. When one of the selectable topic options 332 is selected, the advanced feedback for that topic is displayed in the feedback subpanel 330. The feedback subpanel 330 may include a concise feedback segment 334 and a suggested revision segment 336 that may be provided for each of the different topics in the topic options 332.

In FIG. 4A, the topic option 332 of Overall is selected. The concise feedback segment 334 indicates that there is room for improvement for the draft message. The revision segment 336 indicates a specific portion of the body to be replaced or changed. For instance, the revision segment 336 indicates the current portion of the body (e.g., sentence) and the new portion (e.g., sentence) that should replace the current portion. The current sentence 340 that is being suggested to be revised is also highlighted in the body field 316 so that it is easily identifiable. Highlighting of the current sentence 340 to be revised improves the efficiency for which the suggestion may be assessed, especially for long messages including large amounts of text. The highlighting further reduces the error rate of incorrect sentences being modified by the user rather than the current sentence 340 for which the revision is being suggested. The revision segment 336 also provides an explanation as to why the edits should be made (e.g., “to show more appreciation”). In some examples, the explanation further includes a particular user of a custom profile that is the cause or reason for the feedback. For instance, where a custom profile for User A is included in the AI prompt, the explanation may include a statement such as “User A reacts well when the message includes high amounts of appreciation. To show more appreciation:”.

FIG. 4B depicts another example interface for generating advanced feedback for a message. In particular, FIG. 4B shows the feedback subpanel 330 with the topic option of Tone being selected. When the tone option is selected, the concise feedback segment 334 and the revision segment 336 are updated to provide feedback about the tone of the draft message. In the example depicted, the concise feedback segment 334 indicates that the tone could use more empathy. The revision segment 336 again indicates a current sentence and a sentence to replace the current sentence. In other examples, the proposed modifications or changes may be structures other sentences, such as words, letters, paragraphs, etc. In addition, the explanation is provided, which in this example is “Here's a way the email can offer praise, encouragement, and support to the reader.”

FIG. 4C depicts another example interface for generating advanced feedback for a message. In particular, FIG. 4C depicts the feedback subpanel 330 when the Clarity topic option 332 is selected. When the Clarity option is selected, the concise feedback segment 334 and the revision segment 336 are updated to provide feedback about the clarity of the message. In the example depicted, the clarity of the draft message is good, as indicated in the concise feedback segment 334. As a result, no suggested revisions are presented in the revision segment 336.

FIG. 4D depicts another example interface for generating advanced feedback for a message. In particular, FIG. 4D depicts the feedback subpanel 330 when the Sentiment topic option 332 is selected. When the Sentiment option is selected, the concise feedback segment 334 and the revision segment 336 are updated to display feedback about the sentiment of the message. In the example depicted, the concise feedback segment 334 indicates that the message “might be discouraging.” The revision segment 336 again provides a current sentence of the message that can be replaced by a new sentence. The explanation provided is that the revision can offer praise, encouragement, and support to the reader.

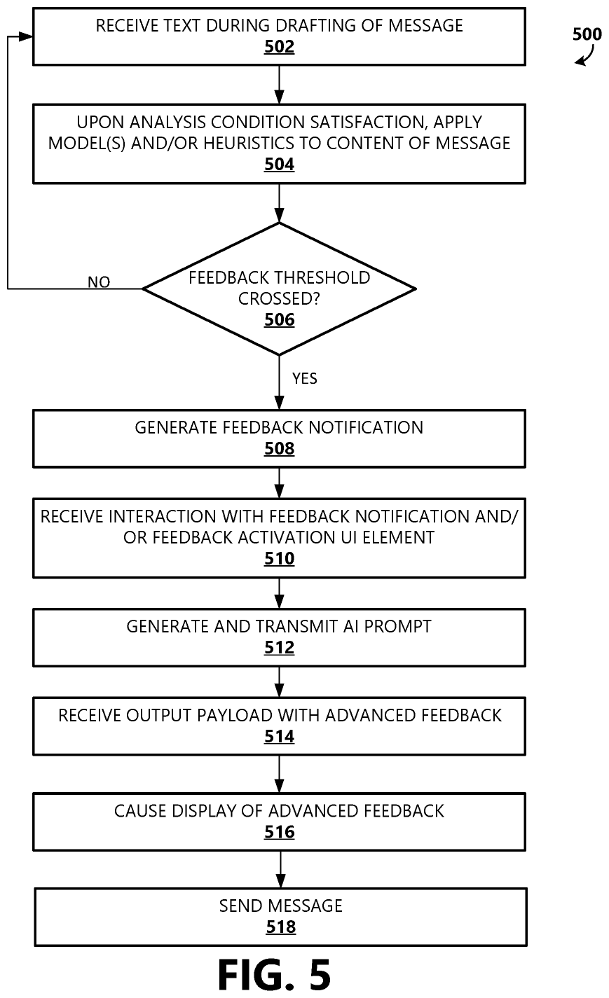

FIG. 5 depicts an example method 500 of generating advanced feedback on messages. The operations of method 500 may be performed by one or more the devices of the systems discussed herein. For instance, a computing device may include at least one processor and memory storing instructions that, when executed by the at least one processor, cause the operations of method 500 to be performed. Operations of method 500 may also be performed by the messaging application itself as well or related components, such as by a local feedback generator.

At operation 502, text and/or other content is received during the drafting a message. For instance, text may be received to populate different fields of the draft message, such as the recipient field, subject field, and body field of the draft message.

As the message is being drafted, an analysis condition is monitored or used to trigger analysis of the message by the heuristics and/or models discussed herein. For instance, the analysis condition may be, or be based on, a time period, an amount of text, entry of a particular character (e.g., tab, return, etc.) and/or a pause, among other conditions. As an example, after the expiration of a time period, the analysis condition may be satisfied. As another example, after a threshold amount of text is entered (e.g., number of characters), the analysis condition may be satisfied. As yet another example, after a pause in typing or text entry is received (e.g., a threshold amount of time passes without text entry), the analysis condition may be satisfied. The above conditions may be combined in some examples.

At operation 504, upon one or more of the analysis conditions being satisfied, the message-analysis model(s) and/or heuristic(s) are applied against the draft message. The heuristics and/or models analyze the message to determine properties and/or characteristics of the message, such as: length of the message (e.g., threshold amount of text); number of recipients (e.g., more than threshold number of recipients indicates feedback likely helpful); the relationship with recipients, hierarchy, affinity, frequency of communication (e.g., messaging a supervisor may benefit from feedback), whether the recipients are internal or external, how much time has been spent working on the draft message, whether it is the first time messaging the recipient, amount of the message that has been retyped, number of times the message has been retyped, profanity, dangerous language, tone or writing style (e.g., not matching tone of other messages in message thread), topics detected in message, advice given in message, emotive terms used in message, urgency of message, and sensitive topics (e.g., diversity, inclusion, death, layoffs), among others.

The different heuristics and/or models may be applied for each of the different categories discussed above. In some examples, each of the models and/or heuristics generate a relative score that is combined to generate a feedback score that is compared to a threshold at operation 506. If the feedback score does not cross the threshold, the method 500 flows back to operation 502 where the method 500 repeats. For instance, additional text is received for the draft message and the analysis conditions are again applied. When the analysis conditions are satisfied, operation 506 is again performed to determine if the feedback threshold is crossed based on the updated message.

If the feedback threshold is crossed in operation 506, the method flows to operation 508 where a feedback notification is generated and/or surfaced within the messaging application. The feedback notification may include the feedback notifications discussed herein, such as the feedback notifications shown in FIGS. 3A-3B.

At operation 510, an interaction with the feedback notification and/or a feedback activation UI element is received. For instance, a user selection of the feedback notification and/or the feedback activation UI element may be received.

At operation 512, an AI prompt is generated based on the draft message. The AI prompt may include the example AI prompts discussed herein and be populated with the data discussed above. For example, the AI prompts may include data from the draft message (e.g., data from or based on the recipient field, the subject field, and/or the body field), conversation details (e.g., prior messages in the message thread), and/or the data generated from the application of the message-analysis models and/or heuristics applied in operation 504. Each of these items may be incorporated into the prompt as dynamic segments. The AI prompt also includes additional static segments, such as the request instructions, output formatting instructions, and/or topic instructions, as discussed above.

Operation 510 also includes transmitting the AI prompt to the language model. The language model processes the received AI prompt as discussed herein. At operation 514, an output payload is received from the language model in response to the AI prompt. The output payload is processed to generate the advanced feedback discussed herein. Processing the output payload may include filtering or cleaning the output payload to ensure inappropriate content was not provided by the language model. The processing also includes further formatting of the data in the output payload into the user interface features of the feedback, as discussed above. For instance, the output payload may be parsed to extract the different elements of the feedback to populate the user interface elements of the messaging application.

At operation 516, the advanced feedback is caused to be displayed by providing the feedback through the messaging application. The advanced feedback may be displayed in multitude of manners, such as through the UI elements discussed above. In some examples, the feedback may be automatically applied to the draft message to generate a modified draft message. For example, as discussed above, the advanced feedback may include recommendations for replacing or changing sentences or other portions of the body of the draft message. An additional option may be displayed with the advanced feedback that, when selected, causes the sentences or identified portions of the body of the draft message to be updated or replaced according to the advanced feedback at operation 520. The changes may be applied separately or selectively for each of the topic options of the advanced feedback. At operation 518, the message is sent to the recipients indicated in the recipient field of the message.

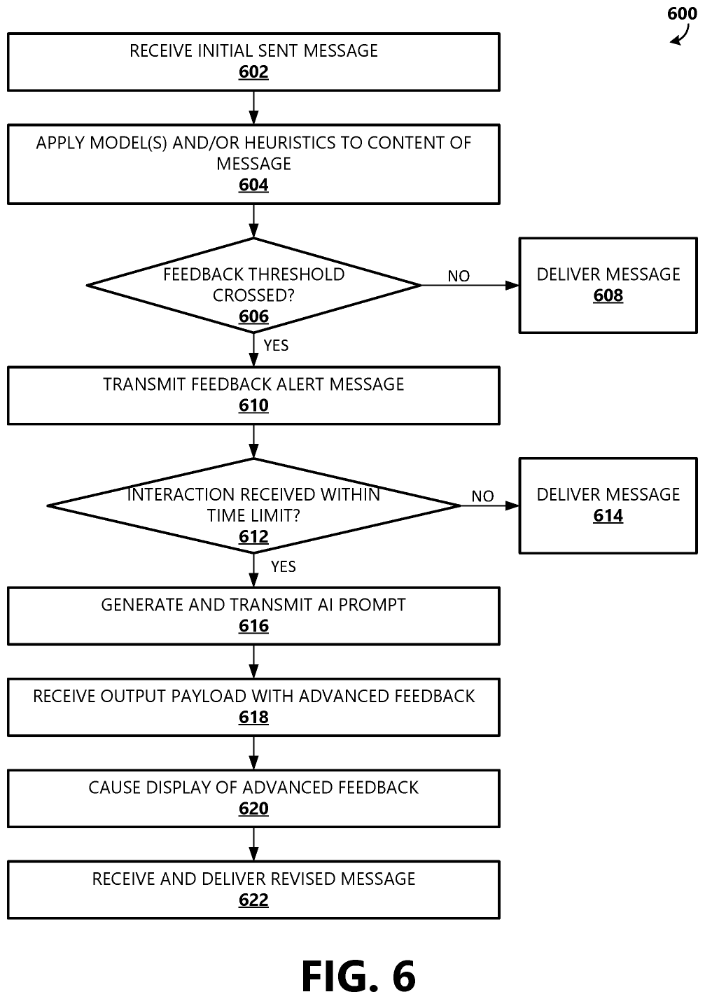

FIG. 6 depicts an example method 600 of generating advanced feedback on messages. The operations of method 600 may be performed by one or more the devices of the systems discussed herein. For instance, a computing device may include at least one processor and memory storing instructions that, when executed by the at least one processor, cause the operations of method 600 to be performed. As an example, the method 600 is performed by a messaging server.

At operation 602, an initial sent message is received. For example, after a user selects the “send” button, a draft message is transmitted to the messaging server, where the messaging server receives the initial sent message.

At operation 604, the message-analysis model(s) and/or heuristic(s) are applied to the initial sent message. Application of the message-analysis model(s) and/or heuristic(s) may be performed as discussed above, such as with respect to operation 504 of method 500. For example, application of the message-analysis model(s) and/or heuristic(s) may include generating one or more feedback scores.

At determination 606, the feedback score(s) are compared to a feedback threshold. If the feedback scores do not cross the feedback threshold, the method 600 flows to operation 608 where the message is delivered to the recipient(s) specified in the message. For instance, the messaging server transmits the initial sent message to the recipients, where the message may then be considered the delivered message.

If, at determination 606, the feedback threshold is crossed, the method 600 flows to operation 610. At operation 610, a feedback alert message is generated and transmitted to the messaging application to cause the feedback alert message to be surfaced in the messaging application. The alert message may be surfaced in the form of another message in the inbox for the user, a popup alert, a push notification, or other type of indication.

At determination 612, a determination is made as to whether an interaction with the alert message and/or a feedback activation UI element is received within a time limit. For example, the time limit may be 30 minutes, 1 hour, or multiple hours, among other time limits. In some examples, the time limit is also customizable by the user. For instance, a configuration user interface may be displayed that allows for the user to configure the time limit.

If the interaction is not received within the time limit, the method 600 flows to operation 614 where the initial sent message is delivered to the recipient(s) specified in the message, and the initial sent message becomes the delivered message. If the interaction is received within the time limit, the method 600 flows to operation 616. Accordingly, when the feedback threshold is crossed, the messaging server holds the initial sent message until the time limit expires or the interaction is received.

At operation 616, an AI prompt is generated and transmitted to a language model for processing. At operation 618, an output payload with the advanced feedback is received from the language model. At operation 620, the advanced feedback is caused to be displayed, such as by causing the advanced feedback to be surfaced in the messaging application used to draft the initial sent message. Operations 616-620 may be substantially similar to operations 512-516 of method 500 except that operations 616-620 are performed on the initial sent message received by the messaging server.

The display of the advanced feedback causes the user to further revise the message according to the advanced feedback. Once the message has been revised, the revised message is again sent to the messaging server (e.g., upon receiving a selection of the “send” button). At operation 622, the revised message is received and delivered to the recipient(s) specified in the message, where the revised message becomes the delivered message.

In the above example methods 500 and 600, the interaction with the alert and/or notification is depicted as occurring before the generation of the AI prompt and feedback generation from the language model. In other examples, however, the generation of the AI prompt and feedback may occur upon the feedback threshold being crossed rather than waiting for an interaction with the alert and/or notification. For instance, by triggering the generation of the advanced feedback upon determining that the message would benefit from such feedback (e.g., when the feedback threshold is crossed), the more time-consuming processing by the language model of the AI prompt may be performed sooner rather than waiting for an explicit input from the user. Then, when the user does interact with the alert, notification, and/or feedback activation UI element, the advanced feedback may be displayed almost instantaneously (or at least faster than having to wait for the language model to process an AI prompt). As a result, the latency involved with processing time associated with the generative AI model may become imperceptible to the user.

FIG. 7 is a block diagram illustrating physical components (e.g., hardware) of a computing device 700 with which examples of the present disclosure may be practiced. The computing device components described below may be suitable for one or more of the components of the systems described above. In a basic configuration, the computing device 700 includes at least one processing unit 702 and a system memory 704. Depending on the configuration and type of computing device 700, the system memory 704 may comprise volatile storage (e.g., random access memory), non-volatile storage (e.g., read-only memory), flash memory, or any combination of such memories. The system memory 704 may include an operating system 705 and one or more program modules 706 suitable for running software applications 750 (e.g., one or more messaging applications 112 and/or feedback generators 110) and other applications.

The operating system 705 may be suitable for controlling the operation of the computing device 700. Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 may perform processes including one or more of the stages of the methods 500 and 600, illustrated in FIG. 5-6. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 700 on the single integrated circuit (chip). Examples of the present disclosure may also be practiced using other technologies capable of performing logical operations such as, for example, AND, OR, and NOT, including mechanical, optical, fluidic, and quantum technologies.

The computing device 700 may also have one or more input device(s) 712 such as a keyboard, a mouse, a pen, a sound input device, a touch input device, a camera, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 704, the removable storage device 709, and the non-removable storage device 710 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer readable media may be part of the computing device 700. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

In an aspect, the technology relates to a system for generating advanced feedback for a draft message using a language model. The system includes at least one processor; and memory storing instructions that, when executed by the at least one processor, cause the system to perform operations. The operations include receive text for a message being drafted in a messaging application; upon an analysis condition being satisfied, analyze the message by applying at least one of a message-analysis model or heuristic to generate a feedback score for the message; based on the feedback score crossing a feedback threshold, trigger generation of advanced feedback for the message. Generation of the advanced feedback includes generate an artificial intelligence (AI) prompt, for a language model, including dynamic and static segments, wherein the dynamic segments are populated with text from the message and the static segments include request instructions; provide the AI prompt as input to the language model; in response to the AI prompt, receive an output payload from the language model; post-process the received output payload to extract advanced feedback for the draft message; and cause a display of the extracted advanced feedback within a user interface of the messaging application.

In an example, the analysis condition includes at least one of expiration of a time period, entry of a threshold amount of text, entry of a particular character, or a pause. In another example, the operations further include, in response to the feedback score crossing the feedback threshold, surface a feedback notification. In yet another example, the feedback notification further includes data generated from applying the at least one of the message-analysis model or the heuristic. In still another example, execution of the message-analysis model or heuristic utilizes fewer computing resources than execution of the language model. In still yet another example, the at least one of the message-analysis model or the heuristic is based on at least one of a length of the message or a number of recipients.

In another example, the at least one of the message-analysis model or the heuristic is based on at least one of a relationship of a sender of the message to one or more recipients of the message, a frequency of communication between the sender of the message and the one or more recipients, or whether the one or more recipients are internal or external to a domain of the sender. In yet another example, the at least one of the message-analysis model or the heuristic is based on at least one of an amount of time spent drafting the message or an amount of the message that has been retyped. In still another example, the at least one of the message-analysis model or the heuristic is based on at least one of profanity, dangerous language, emotive terms, or sensitive topics within the message. In still yet another example, the AI prompt further includes data generated from application of the at least one of the message-analysis model or the heuristic.

In another aspect, the technology relates to a messaging-server system for generating advanced feedback for a message using a language model. The system includes at least one processor; and memory storing instructions that, when executed by the at least one processor, cause the system to perform operations. The operations include receive an initial sent message from a messaging application; analyze the message by applying at least one of a message-analysis model or heuristic to generate a feedback score for the message; based on the feedback score crossing a feedback threshold, transmit a feedback alert message for surfacing in the messaging application; receive an indication of an interaction with at least one of the feedback alert message or a feedback activation user interface element; based on receiving the indication of the interaction, trigger generation of advanced feedback for the message. Generation of the advanced feedback includes generate an artificial intelligence (AI) prompt, for a language model, including dynamic and static segments, wherein the dynamic segments are populated with text from the message and the static segments include request instructions; provide the AI prompt to the language model; in response to the AI prompt, receive an output payload from the language model including the advanced feedback; and cause a display of the advanced feedback within a user interface of the messaging application.

In an example, the operations further include receiving a revised draft of the message that has been revised according to the advanced feedback; and delivering the revised draft of the message to one or more recipients indicated in the message, without applying the at least one of the message-analysis model or heuristic against the revised draft of the message. In yet another example, the feedback alert message further includes data generated from applying the at least one of the message-analysis model or the heuristic. In still another example, execution of the message-analysis model or heuristic utilizes fewer computing resources than execution of the language model. In still yet another example, the AI prompt further includes data generated from application of the at least one of the message-analysis model or the heuristic.

In another aspect, the technology relates to a computer-implemented method for generating advanced feedback for a draft message using a language model. The method includes receiving text for a draft message being drafted in a messaging application; upon an analysis condition being satisfied a first time, analyzing the draft message by applying at least one of a message-analysis model or heuristic to generate a first feedback score for the message, wherein the first feedback score is below a feedback threshold; receiving additional text for the draft message; upon an analysis condition being satisfied a second time, after receiving the additional text, analyzing the draft message by applying the at least one of the message-analysis model or heuristic to generate a second feedback score for the message, wherein the second feedback score exceeds the feedback threshold; based on the second feedback score crossing a feedback threshold, surfacing a feedback notification in the messaging application; receiving an indication of an interaction with the feedback notification or a feedback activation user interface element; and triggering generation of advanced feedback for the message. Generation of the advanced feedback includes generating an artificial intelligence (AI) prompt, for a language model, including dynamic and static segments, wherein the dynamic segments are populated with text from the message and the static segments include request instructions; providing the AI prompt as input to the language model; in response to the AI prompt, receiving an output payload from the language model including advanced feedback for the draft message; and causing a display of the extracted advanced feedback within the user interface of the messaging application.

In an example, the feedback notification is surfaced in the messaging application that does not occlude the additional text of the draft message. In a further example, the feedback notification includes data generated from applying the at least one of the message-analysis model or the heuristic. In still another example, triggering the generation of the advanced feedback is based on receiving the interaction. In yet another example, triggering the generation of the advanced feedback is based on the feedback score crossing a feedback threshold; and causing the display of the advanced feedback is based on receiving the interaction.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A system for generating advanced feedback for a draft message using a language model, comprising:
at least one processor; and
memory storing instructions that, when executed by the at least one processor, cause the system to perform operations comprising:
receive text for a message being drafted in a messaging application;
upon an analysis condition being satisfied, analyze the message by applying at least one of a message-analysis model or heuristic to generate a feedback score for the message;
based on the feedback score crossing a feedback threshold, trigger generation of advanced feedback for the message, wherein generation of the advanced feedback comprises:
generate an artificial intelligence (AI) prompt, for a language model, including dynamic and static segments, wherein the dynamic segments are populated with text from the message and the static segments include request instructions;
provide the AI prompt as input to the language model;
in response to the AI prompt, receive an output payload from the language model;
post-process the received output payload to extract advanced feedback for the draft message; and
cause a display of the extracted advanced feedback within a user interface of the messaging application.

2. The system of claim 1, wherein the analysis condition includes at least one of expiration of a time period, entry of a threshold amount of text, entry of a particular character, or a pause.

3. The system of claim 1, wherein the operations further comprise, in response to the feedback score crossing the feedback threshold, surface a feedback notification.

4. The system of claim 3, wherein the feedback notification further includes data generated from applying the at least one of the message-analysis model or the heuristic.

5. The system of claim 1, wherein execution of the message-analysis model or heuristic utilizes fewer computing resources than execution of the language model.

6. The system of claim 1, wherein the at least one of the message-analysis model or the heuristic is based on at least one of a length of the message or a number of recipients.

7. The system of claim 1, wherein the at least one of the message-analysis model or the heuristic is based on at least one of a relationship of a sender of the message to one or more recipients of the message, a frequency of communication between the sender of the message and the one or more recipients, or whether the one or more recipients are internal or external to a domain of the sender.

8. The system of claim 1, wherein the at least one of the message-analysis model or the heuristic is based on at least one of an amount of time spent drafting the message or an amount of the message that has been retyped.

9. The system of claim 1, wherein the at least one of the message-analysis model or the heuristic is based on at least one of profanity, dangerous language, emotive terms, or sensitive topics within the message.

10. The system of claim 1, wherein the AI prompt further includes data generated from application of the at least one of the message-analysis model or the heuristic.

11. A messaging-server system for generating advanced feedback for a message using a language model, comprising:
at least one processor; and
memory storing instructions that, when executed by the at least one processor, cause the system to perform operations comprising:
receive an initial sent message from a messaging application;
analyze the message by applying at least one of a message-analysis model or heuristic to generate a feedback score for the message;
based on the feedback score crossing a feedback threshold, transmit a feedback alert message for surfacing in the messaging application;
receive an indication of an interaction with at least one of the feedback alert message or a feedback activation user interface element;
based on receiving the indication of the interaction, trigger generation of advanced feedback for the message, wherein generation of the advanced feedback comprises:
generate an artificial intelligence (AI) prompt, for a language model, including dynamic and static segments, wherein the dynamic segments are populated with text from the message and the static segments include request instructions;
provide the AI prompt to the language model;
in response to the AI prompt, receive an output payload from the language model including the advanced feedback; and
cause a display of the advanced feedback within a user interface of the messaging application.

12. The messaging-server system of claim 11, wherein the operations further comprise:
receiving a revised draft of the message that has been revised according to the advanced feedback; and
delivering the revised draft of the message to one or more recipients indicated in the message, without applying the at least one of the message-analysis model or heuristic against the revised draft of the message.

13. The messaging-server system of claim 11, wherein the feedback alert message further includes data generated from applying the at least one of the message-analysis model or the heuristic.

14. The messaging-server system of claim 11, wherein execution of the message-analysis model or heuristic utilizes fewer computing resources than execution of the language model.

15. The messaging-server system of claim 11, wherein the AI prompt further includes data generated from application of the at least one of the message-analysis model or the heuristic.

16. A computer-implemented method for generating advanced feedback for a draft message using a language model, comprising:
receiving text for a draft message being drafted in a messaging application;
upon an analysis condition being satisfied a first time, analyzing the draft message by applying at least one of a message-analysis model or heuristic to generate a first feedback score for the message, wherein the first feedback score is below a feedback threshold;
receiving additional text for the draft message;
upon an analysis condition being satisfied a second time, after receiving the additional text, analyzing the draft message by applying the at least one of the message-analysis model or heuristic to generate a second feedback score for the message, wherein the second feedback score exceeds the feedback threshold;
based on the second feedback score crossing a feedback threshold, surfacing a feedback notification in the messaging application;
receiving an indication of an interaction with the feedback notification or a feedback activation user interface element; and
triggering generation of advanced feedback for the message, wherein generation of the advanced feedback comprises:
generating an artificial intelligence (AI) prompt, for a language model, including dynamic and static segments, wherein the dynamic segments are populated with text from the message and the static segments include request instructions;
providing the AI prompt as input to the language model;
in response to the AI prompt, receiving an output payload from the language model including advanced feedback for the draft message; and
causing a display of the extracted advanced feedback within the user interface of the messaging application.

17. The computer-implemented method of claim 16, wherein the feedback notification is surfaced in the messaging application that does not occlude the additional text of the draft message.

18. The computer-implemented method of claim 17, wherein the feedback notification includes data generated from applying the at least one of the message-analysis model or the heuristic.

19. The computer-implemented method of claim 16, wherein triggering the generation of the advanced feedback is based on receiving the interaction.

20. The computer-implemented method of claim 16, wherein:
triggering the generation of the advanced feedback is based on the feedback score crossing a feedback threshold; and
causing the display of the advanced feedback is based on receiving the interaction.
